(19) United States
(12) Patent Application Publication
(10) Pub. No.: US 2010/0177437 A1
(43) Pub. Date: Jul. 15, 2010

(54) Method for Bipolar Trailing Edge Timing-Based Servo Track Recording and Magnetic Tape Made Therewith

(76) Inventor: Gregory Lawrence Wagner, Arden Hills, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/539,539

(22) Filed: Aug. 11, 2009

Related U.S. Application Data
(60) Provisional application No. 61/087,895, filed on Aug. 11, 2008.
(60) Provisional application No. 61/113,907, filed on Nov. 12, 2008.
(60) Provisional application No. 61/143,291, filed on Jan. 8, 2009.

(51) Int. Cl. G11B 5/584

(52) U.S. Cl. 360/77.12; G9B/5.203

(57) ABSTRACT

The present disclosure relates to the minimization of servo format transition bit length of magnetic recording media. More particularly, the present disclosure relates to bi-polar and trailing edge recording when formatting the servo track of magnetic recording media. In one embodiment, magnetic media having a timing-based pattern is written using a bi-polar energized recording head. In some embodiments, the magnetic media may be AC or DC erased. The recording head may include a plurality of independent recording channels, each of which may be magnetically energized individually. The bi-polar energized state of the recording head may be controlled to vary the bit length and bit sequence within the timing-based pattern. In further embodiments, the magnetic media may include both uni-polar and bi-polar transitions.

This application claims benefit to Provisional Applications Nos. 61/087,895 (filed Aug. 11, 2008), 61/113,907 (filed Nov. 12, 2008), and 61/143,291 (filed Jan. 8, 2009), the contents of which are herein incorporated by reference in their entirety.

### FIELD OF THE INVENTION

The present disclosure relates to the minimization of servo format transition bit length for magnetic recording media. More particularly, the present disclosure relates to bi-polar and trailing edge recording when formatting the servo track(s) of magnetic recording media.

### BACKGROUND OF THE INVENTION

In the magnetic tape data storage industry, data is stored as a sequential stream of magnetic transitions (bits), written in a series of adjacent tracks down the length of tape. A data track is one data channel located in a band of data channels. A band or group of data channels, commonly referred to as a “data band,” commonly have servo channels on either side of the data band. Magnetic write and read heads follow the tracks of data down the length of tape, writing and reading the information contained in the magnetic transitions on a particular data track or channel.

When magnetic heads read and write the data of a chosen track, it is important that the heads not read and/or write data from/on adjacent tracks. In writing operations, the failure to stay on the chosen track results in the adjacent track data being overwritten, and hence data loss. In read-back operations, failure to stay on track results in contaminated data from detection of adjacent track transitions. In the preceding write and read examples, even going off track into a so-called guard band results in a loss of signal to noise. Thus, staying on track is very important in both write and read operations. The Position Error Signal (PES) is a parametric value, well known in the industry, used to quantify how tightly the read/write head can stay on track.

In current and future generations of magnetic tape, the width of the data tracks and the distances between adjacent data tracks are sufficiently small that the undesirable static displacement of a track (temperature and humidity effects), as well as variations in the guiding of the tape (referred to as Linear Tape Motion (LTM)), result in the need for compensation to allow proper tracking during read/write operations. This is accomplished through active servo-following utilizing magnetically written servo tracks.

Magnetic servo tracks are written into the media in the tape manufacturer production facility in large reels of tape that are subsequently cut to make many tape cartridges. The operation is carried out on very large servowriter systems which resemble large open reel tape decks. These servo tracks are written into the tape in specific, well-controlled positions on the tape. The type of servo tracks used depends on the specific tape format. One such format is Linear Tape Open (LTO), a Timing-Based Servo (TBS) formatting scheme.

There are multiple servo tracks formatted into the tape. These tracks are designed to functionally span the tape width, and are never over-written while the tape is in use. Servo tracks are the system metric used for track following, and hence should be written as accurately as possible. TBS refers to the scheme wherein the servo system calculates its position based on the periodicity of the servo read signal. The servo tracks are sensed by a magnetic read head while the tape is traveling. By actively monitoring the PES, and thus the movement of the tape relative to the head, the read/write data heads can be dynamically positioned to a desired location. Because of the requirement to measure the signal's periodicity, the linear density of the servo track determines the number of PES measurements for a given length of tape. As data track densities increase in future generations of media, the local linear bit density of the servo transitions will need to also increase to maintain sufficient PES tracking information.

In current technology TBS recording systems, the servo format magnetic transitions are printed onto the tape by inducing a unidirectional magnetic field in the recording gap(s) in the servowriter head. Referred to as uni-polar servowriting, this type of magnetic recording is created when the head is energized utilizing a uni-polar current pulse so that the magnetic image of the entire head gap is imprinted onto the tape. This operation is performed as the magnetic tape is traveling over the magnetic head and the recording gap. This results in a read-back signal of an output pulse due to the leading magnetic transition, and an output pulse of opposite polarity due to the trailing magnetic transition. If the tape is bulk DC-erased, the unidirectional magnetic field in the recording gap(s), and thus the uni-polar current pulse, must be such that it imprints the magnetic transition in the opposite direction of the DC erase state of the media, otherwise it will not cause a magnetization change in the media.

By alternating between turning the head off and energizing the servowriter head with a series of uni-polar current pulses, a series of magnetic transitions are written on the magnetic tape. In TBS recording these series of transitions are created using a uni-polar electrical current pulse, resulting in a full image of the magnetic gap being imprinted onto the tape. Before writing the servo format transitions, the magnetic tape is erased such as to make the local magnetization state of the media effectively zero (AC erased). The media can then be magnetized either “up” or “down” depending on the TBS formatting scheme. As an alternate approach, the media can be first DC magnetized in one state, either “up” or “down”, and then servowritten. In such a case, the tape would be DC magnetized using a magnetic recording head with a constant current being driven through the head in order to produce a constant state of magnetization on the tape. The media would then be formatted using a servo head utilizing the aforementioned uni-polar technique. One advantage of the DC pre-erasure is that the read-back magnitude of the transition between magnetic states (bits) from a DC erased tape is approximately twice that of a magnetic tape having zero magnetization before formatting. Therefore the PES will have a higher signal-to-noise ratio, resulting in better servo tracking.

One deficiency of this uni-polar servowriting method for creating TBS recording patterns is that the minimum bit length (i.e., the length of the magnetic transition in the tape traveling direction) is at least as large as the magnetic head recording gap. In practice, the magnetic field from the recording gap is slightly larger than the physical recording gap on the head. Additionally, the pulse width of the electrical current pulse used to drive the servo head is limited by the capability of even the most state of the art electronics, and hence has a finite, non-zero width and time duration. As a result, the bit transition length resulting from uni-polar servowriting is always larger than the physical gap length of the recording head. In practice, fabrication technology of TBS format heads limits the minimum physical gap that can be produced in a recording head. Thus, when utilizing uni-polar servo formatting, the minimum bit length producible on tape is constrained by state of the art fabrication capability.

The servo system of a data storage system which utilizes TBS is generally comprised of, magnetic transducers (read and write elements on one or more heads), a signal amplification and filtering system (preamplifiers), signal decoders, a servo controller, and a translation mechanism. The read heads detect the magnetic transitions recorded on the media and convert them into electrical signals. These signals are amplified and filtered so as to increase the signal-to-noise ratio, thus reducing errors in the signal. The signal is decoded to extract the position information provided by the servo patterns. This position information is used by the servo controller to determine the difference between the measured position and the desired position. This difference, known as the position error signal (PES), is used to adjust the read/write head(s) by means of a translation mechanism. Such a system is described in U.S. Pat. No. 5,689,384, “Timing Based Servo System for Magnetic Tape Systems,” to Albrecht et al., the contents of which are herein incorporated by reference in their entirety.

For the servo system to calculate a single PES, a fixed length of tape must travel across the head(s). The longer this length is, the greater the chance is for the tape to move in the lateral (undesirable) direction, and thus invoke tracking errors. Therefore it is desirable to calculate a PES using the shortest length of tape required. In order to decrease the length of tape required, the linear density of the servo track must be increased.

As tape technology advances, a primary need in the art is to increase the number of data tracks, and hence the recording density, on a given magnetic tape. This requires greater accuracy and capability of the servo system, which requires greater capability of the servo track formatting. There are a large number of characteristics which can be enhanced or changed to affect the servo tracking capability, however, fundamental to advanced tape data storage systems is higher servo bit sampling rate and faster down-track servo position updates. The servo bit sampling rates and servo position updates are utilized in commercial data storage system track-following electronics, software. Both the sampling rate and the position update rate are affected by the minimum bit length of the servo transition.

FIG. 1 is an illustration of the uni-polar servowriting process in a TBS servo system in the uni-polar written magnetic region. Note that in this figure, only one gap is shown for simplicity and clarity. For a timing-based servo, a plurality of gaps are driven at the same time. Further, the read-back wave form is highly stretched out in the length scale. As shown at (a), there is depicted a head gap cartoon 101 having a gap in between a permeable pole. At (b), a write current 102 is applied at the gap 101. At (c), media magnetization 103 is depicted as a result of the applied write current 102. Last, at (d), the resulting read-back waveform 104 is depicted.

As a further example, consider a TBS uni-polar servowritten pattern such as used by the LTO format. In this case, a series of magnetic bits 201 are written onto the recording tape as shown in FIG. 2. As illustrated, the recording bit length is approximately 2.1 μm with a pitch between bits of approximately 5 μm. The uni-polar pattern was written using a recording head having a 1.5 μm physical gap. Hence, with respect to the physical space on tape, five (5) magnetic bits require nearly 25 μm of space in the down tape direction. If the magnetic bit length could be reduced to 1 μm, with a pitch between uni-polar pulses reduced to 2 μm, the same number of bits could be contained in 10 μm of physical space, resulting in a higher servo sampling rate and a faster tape position update to the servo system.

Thus, there exists a need in the art for minimizing the servo format transition bit length. Such minimization can affect the servo performance and capability, enabling higher track density recording systems. Particularly, there is a need in the art for a method for bi-polar, trailing edge, timing-based servo track recording. There is also a need in the art for magnetic media formatted using a method for bi-polar, trailing edge, timing-based servo track recording.

### BRIEF SUMMARY OF THE INVENTION

The present disclosure, in one embodiment, relates to magnetic media having a timing-based pattern written using a bi-polar energized recording head. In another embodiment, the present disclosure relates to a timing-based pattern written on magnetic media using a bi-polar energized recording head and/or utilizing trailing edge recording. In some embodiments, the magnetic media may be AC or DC erased. The recording head may include a plurality of independent recording channels, each of which may be magnetically energized individually. The bi-polar energized state of the recording head may be controlled to vary the bit length and bit sequence within the timing-based pattern. In further embodiments, the magnetic media may include both uni-polar and bi-polar transitions.

The present disclosure, in another embodiment, relates to a method for formatting a magnetic media. The method comprises writing a timing-based pattern on the magnetic media using a bi-polar energized recording head. The method may further comprise DC erasing the magnetic media and controlling the head so that the head is energized in such a way that the resulting timing-based pattern is directionally symmetric with respect to the tape streaming direction of the media.

In another embodiment, the present disclosure relates to controlling the electronic drive current profile to the recording head such that the final magnetic transition on the media, of any sequence of transitions, mitigates or removes any residual or undesirable magnetic artifacts on the magnetic media.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is an illustration of a uni-polar servowriting process in a TBS servo system in the uni-polar written magnetic region.

FIG. 2 is a magnetic image of a series of magnetic bits written onto recording media using uni-polar writing.

FIG. 3 is a magnetic image of a series of magnetic transitions, similar in scale to FIG. 2, written using bi-polar recording in accordance with one embodiment of the present invention.

FIG. 4 is a diagram of bi-polar recording in accordance with one embodiment of the present invention.

FIG. 5 is a magnetic image of magnetic media having magnetic transitions written using bi-polar writing.

FIG. 6 is an image of magnetic media having magnetic transitions written using bi-polar writing.

FIG. 7 is an image of magnetic media having magnetic transitions written using bi-polar writing.

FIG. 8 is an illustration of a read-back waveform form utilizing uni-polar servo writing on tape media which supports a perpendicular component.

FIG. 9 is a diagram illustrating a bi-polar recording in accordance with one embodiment of the present invention.

FIG. 10 is a read-back wave form utilizing bi-polar servo writing on tape media which supports a perpendicular component. In this illustrative example, the media has been Pre-DC Erased.

FIG. 11 is a schematic representation of bi-polar, trailing edge recording of two recording gaps and the resulting bit transitions on magnetic media.

FIG. 12 is read-back wave form utilizing bi-polar servo writing on tape media which supports a perpendicular component. This media has been Pre-DC Erased. In this embodiment, the bi-polar write current was shut off in a controlled manner.

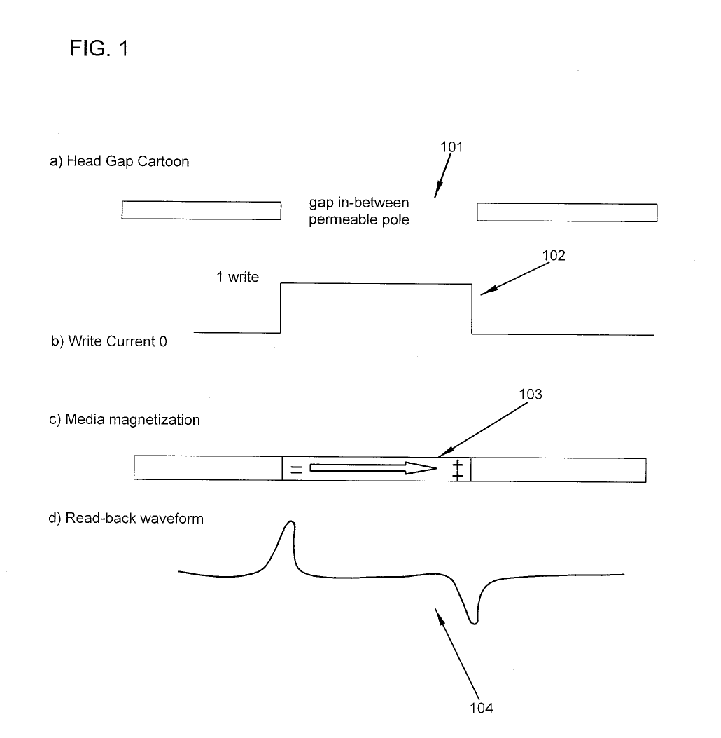

### DETAILED DESCRIPTION

The present disclosure relates to the minimization and dynamic variable control of servo format transition bit length of magnetic recording medium. More particularly, the present disclosure relates to novel and advantageous methods for bi-polar and trailing edge recording when formatting the servo track of magnetic recording medium, magnetic recording media made therewith and data storage systems which utilize the formatted media for servo track-following operations. The minimization of servo format transition bit length can be used to advance the state of the art magnetic recording systems. This minimization will affect the servo performance and capability, enabling higher track density recording systems.

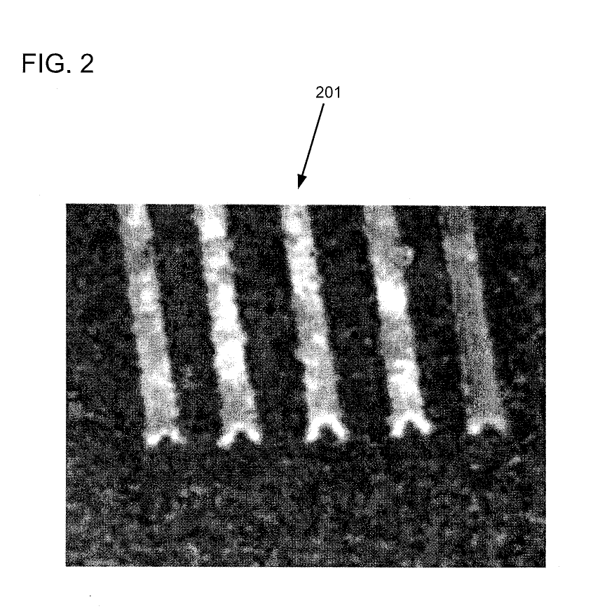

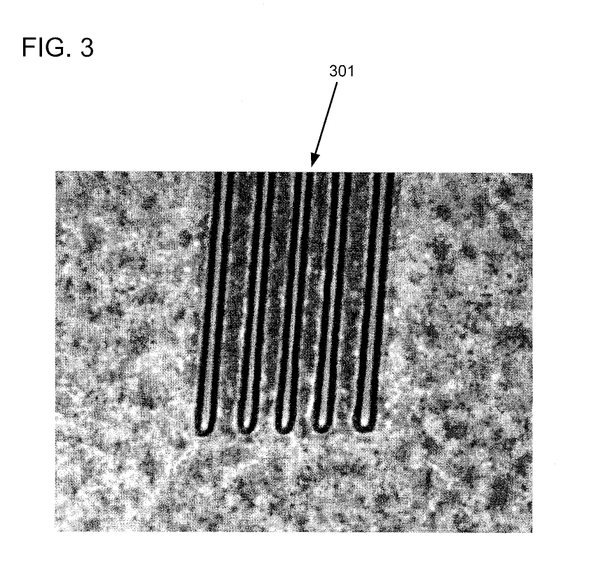

In the various embodiments of the present disclosure, a TBS recording pattern may be written using a bi-polar writing technique. Instead of energizing the magnetic recording head with only a uni-polar electrical pulse and effectively turning the recording head “on” and “off,” the head is energized with a bi-polar electrical pulse and switched between opposite magnetically energized states. This results in a bit transition of magnetic magnitude generally equal to that of a DC erased tape, except the recoding is done utilizing a single head operation, instead of with two recording heads. Energizing and de-energizing the magnetic recording head may be done using any suitable electronics and software. An image of a series of magnetic transitions 301, similar in scale to FIG. 2, but written using bi-polar recording, is shown in FIG. 3.

Driving the head with a bi-polar pulse, also allows the TBS encoding to be performed utilizing trailing edge recording. In trailing edge recording, the head is first energized in one direction, resulting in the image of the entire head gap being imprinted onto the tape. As the tape translates past the recording gap, the magnetic energized state of the head is reversed, before the entire imaged bit has cleared the gap. This results in the latter portion of the magnetic bit on tape being overwritten to a different state. If this is done in succession, the effective magnetic bit length written on tape is a function of the overwrite frequency, not simply the physical gap length of the recording head. As a result, trailing edge recording, utilizing bi-polar energizing of the magnetic head, allows arbitrary bit length magnetic recording of the TBS pattern. Thus, magnetic bit lengths on tape can be substantially reduced and variably controlled. This allows recorded bit lengths that are much less than the length of the physical recording gap on the magnetic recording head.

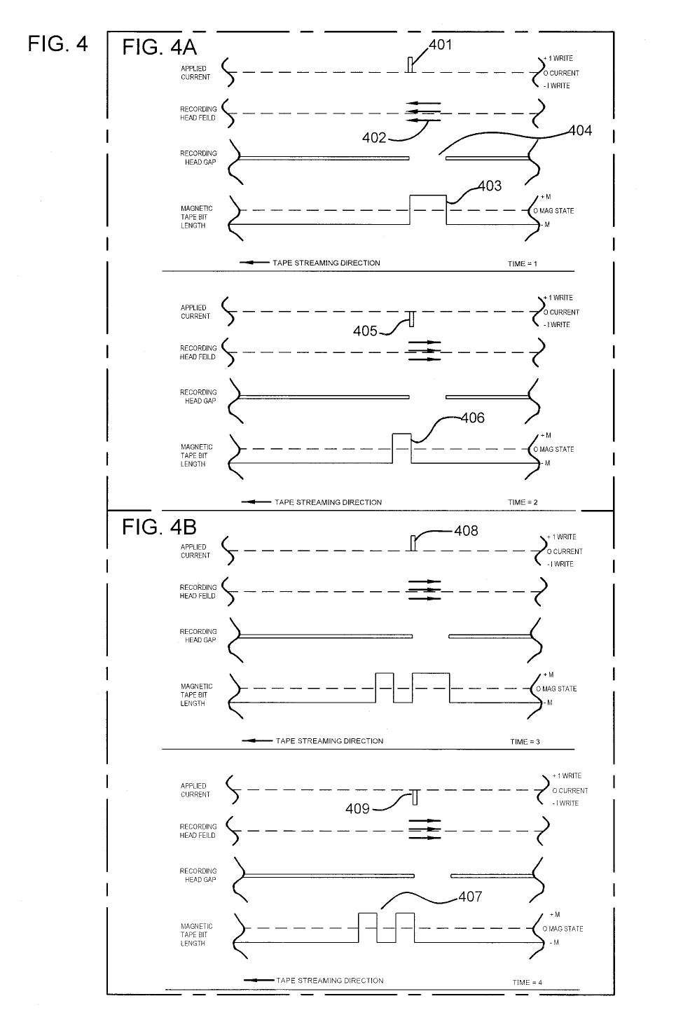

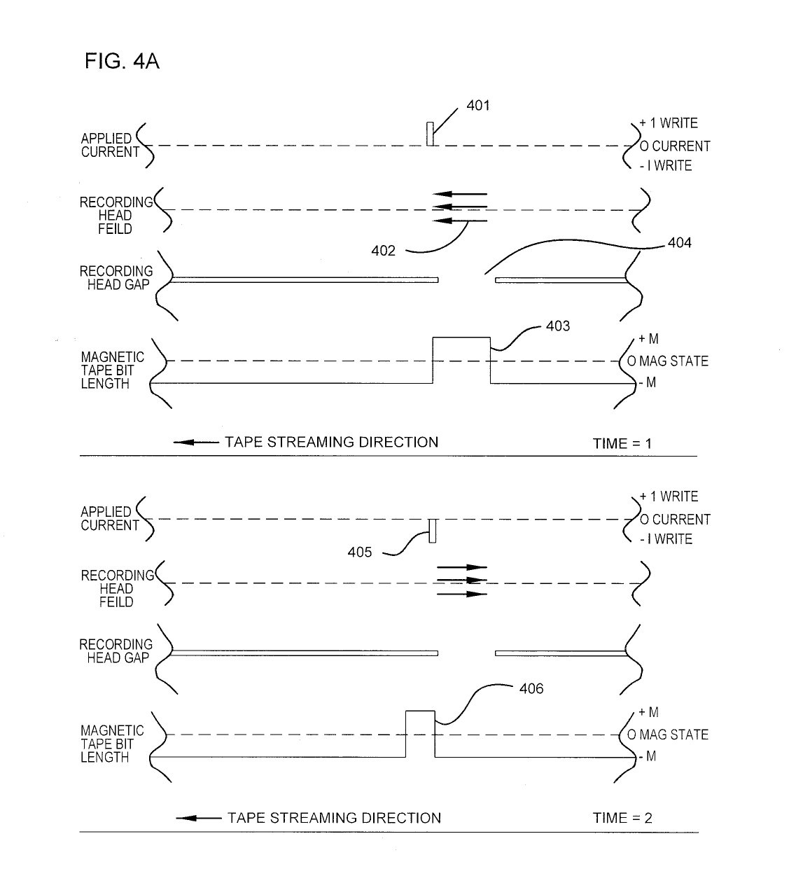

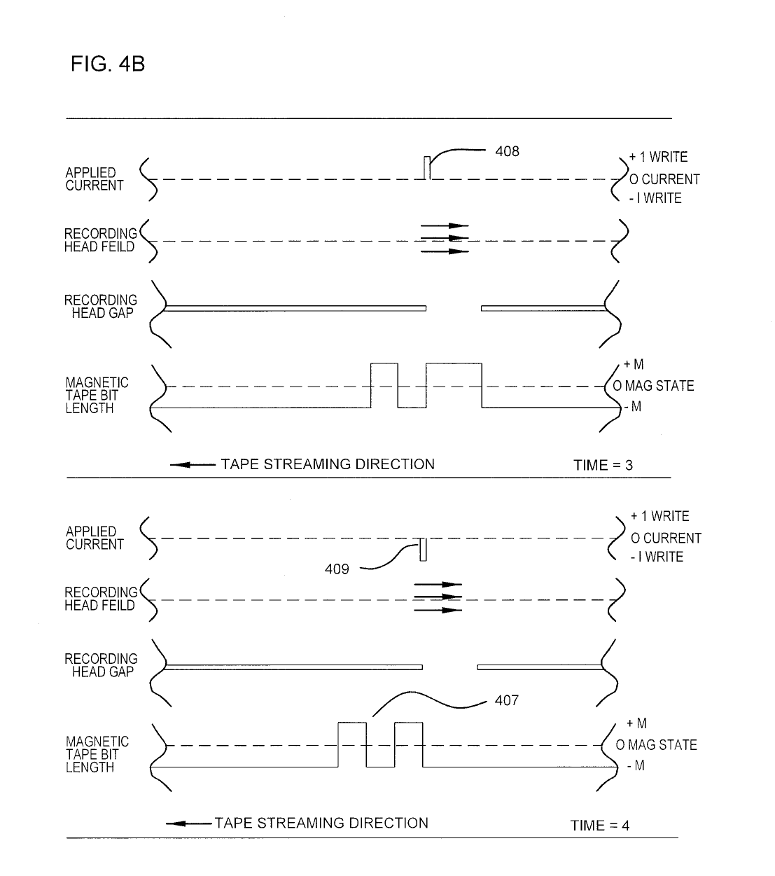

One example embodiment of this technique is illustrated in FIG. 4. Initially, in some embodiments, the magnetic media may be AC or DC erased. At TIME=1, the head gap can be energized by means of an applied current pulse +I WRITE 401. This current creates a directional recording head field in the head gap, depicted by the arrows 402 in the figure. In this illustration, the tape is streaming right to left, and a magnetic transition (bit) is imprinted (written) into the media. The resulting written bit 403 is shown magnetized (+M) in the opposite state of the magnetization of the original media (−M). This is illustrated by the Magnetic Tape Bit Length at TIME=1, in FIG. 4. This illustration, at TIME=1 in FIG. 4, is an example of uni-polar writing. The width of the illustrative magnetic transition is defined by the length of the Recording Head Gap 404. At TIME=2, the media has streamed approximately half the distance, or other suitable distance, of the physical recording gap on the head. The head can then be magnetically energized in the opposite sense by supplying a current pulse −I WRITE 405, reversing the state of the magnetic recording head field in the head gap. Pulsing at +I WRITE and −I WRITE is an example of bi-polar recording. As can be seen at TIME=2, a portion of the previously written bit 406 is then overwritten to its prior state of magnetization (−M). At TIME=3 and TIME=4, this process can be repeated, pulsing at +I WRITE 408 at TIME=3 and pulsing at −I WRITE 409 at TIME=4. At TIME=4, the result is the effective recording of magnetic transitions 407 whose bit length is smaller than the physical recording gap. The process may be repeated any suitable number of times according to the specified or desired TBS pattern. This is an example of bi-polar trailing edge time-based servo track recording.

As can be seen from FIG. 4, if the initial state of magnetization of the media is the same in direction and magnitude as the final state of the magnetization of the media, as produced by the recording head, the final recorded transition length of a bit series 407 is controllable. This may be desirable as the pattern can then be printed symmetrically with respect to tape streaming direction.

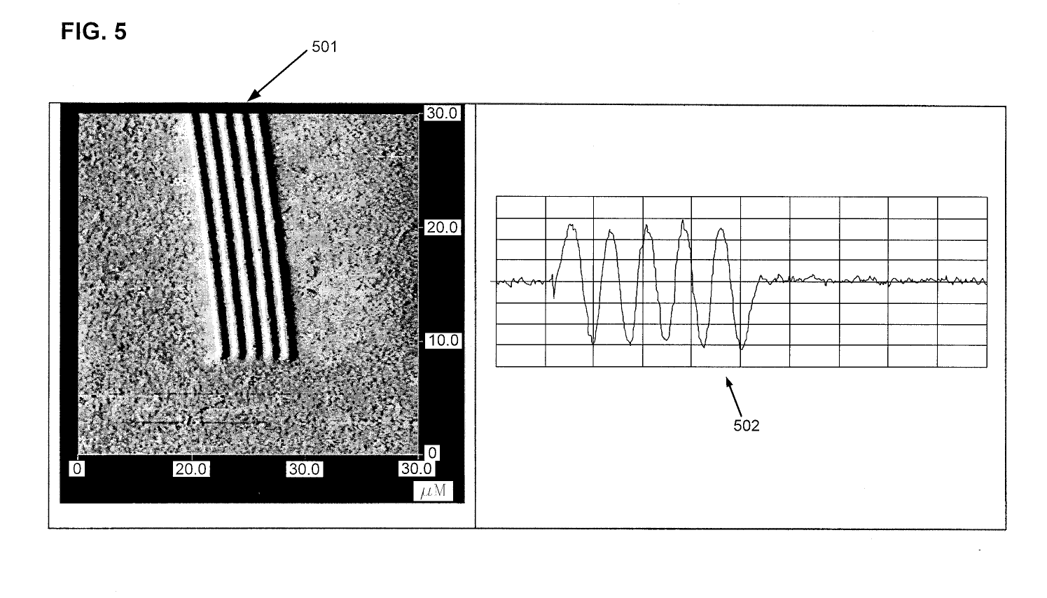

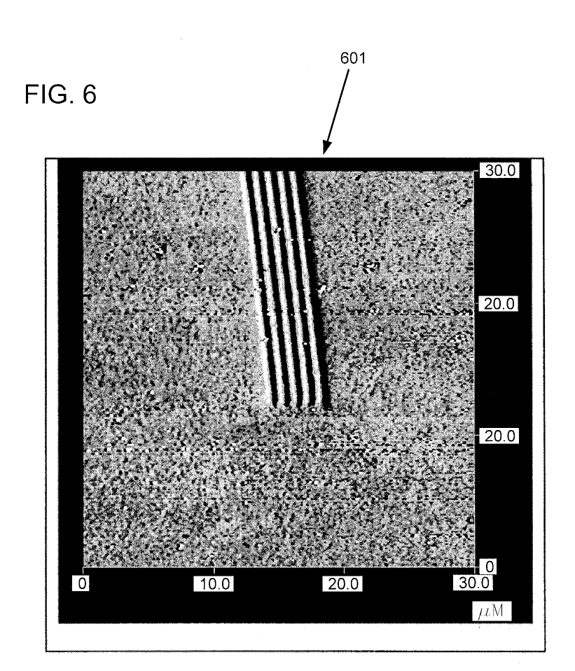

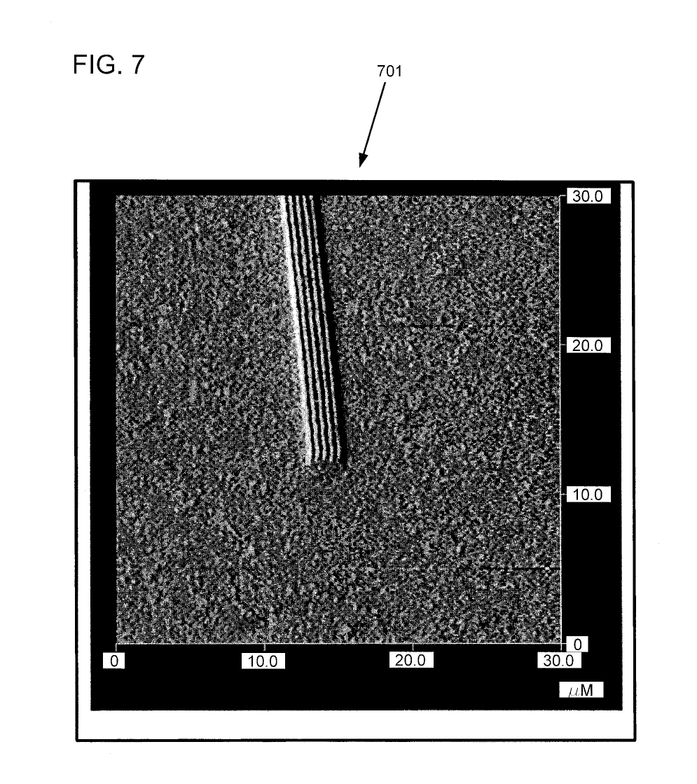

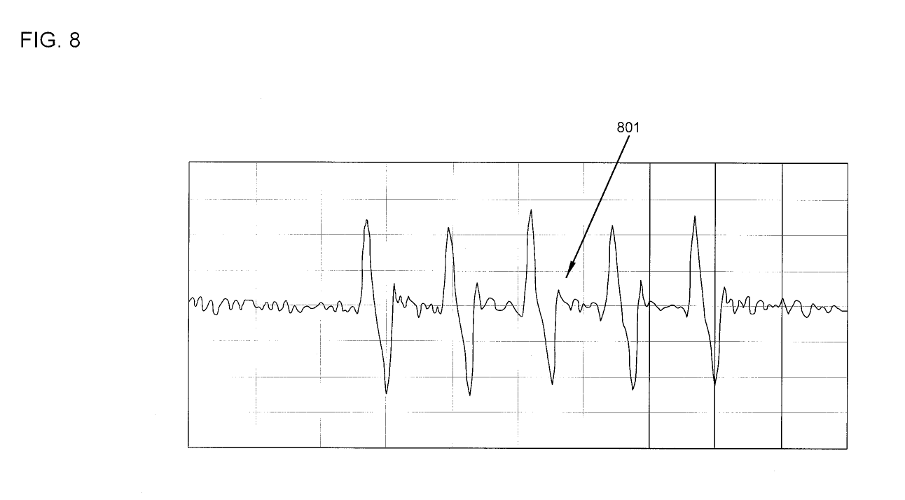

FIGS. 5-7 are illustrative embodiments of magnetic transitions 501, 601, 701 on media written using bi-polar writing to produce various magnetic transition bit lengths. FIG. 5 also includes an illustrative example of the corresponding read-back signals 502 from the magnetic transitions. The bi-polar written magnetic transition lengths on media presented therein are 0.75 μm with a pitch of 1.5 μm in FIG. 5, 0.5 μm with a pitch of 1.0 μm in FIGS. 6, and 0.25 μm with a pitch of 0.5 μm in FIG. 7. The physical gap on the magnetic recording head used to write these transitions was approximately 0.6 μm. The 0.6 μm gap produced a 0.9 μm magnetic transition on tape when written at the same parameters using the uni-polar writing technique. FIG. 8 is an illustration of a read-back waveform 801 form using the uni-polar technique.

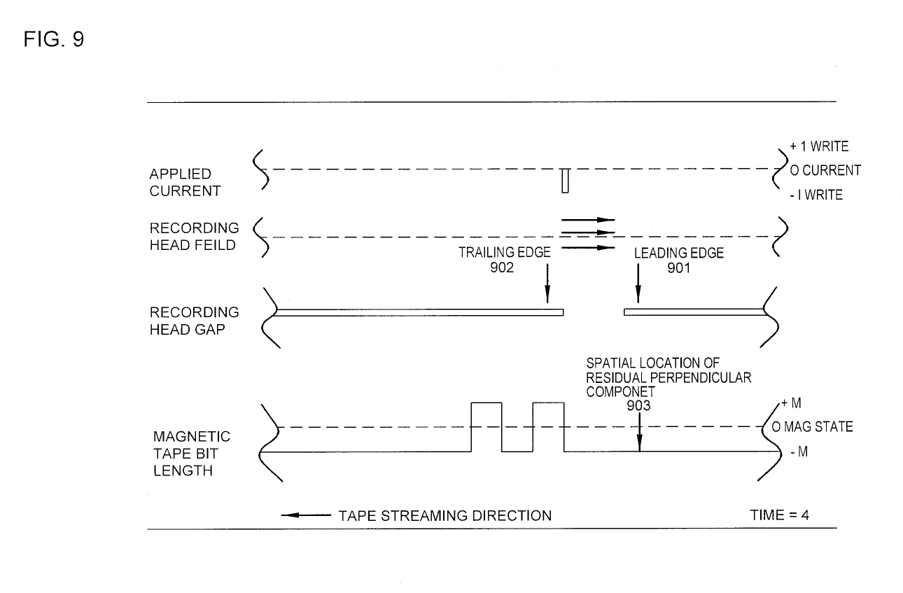

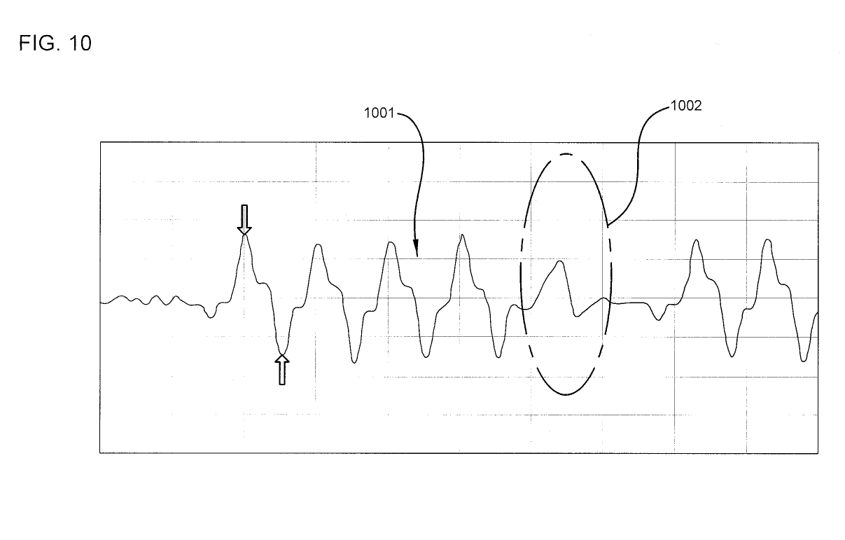

The illustrative examples described herein have been of media which only significantly supports horizontal magnetized states. Future magnetic tape media may support perpendicular magnetized states as well as horizontal magnetized states. In practice, the leading and trailing edges of the Recording Head Gap magnetic field produce a perpendicular component. The leading edge 901 and trailing edge 902 of the Recording Head Gap are illustrated in FIG. 9. If the magnetic media supports a perpendicular magnetization component, this may lead to a low amplitude, local perpendicular magnetized artifact written on the media during the last overwrite cycle of the recording head. The relative spatial location of this residual magnetization 903 is depicted in FIG. 9. FIG. 10 is a read-back wave form 1001 utilizing bi-polar servo writing on tape media which supports a perpendicular component. In this illustrative example, the media has been Pre-DC Erased. The residual signal 1002 is circled for clarity. This residual signal may be present on the magnetic media. In this embodiment, the bi-polar write current was simply switched off.

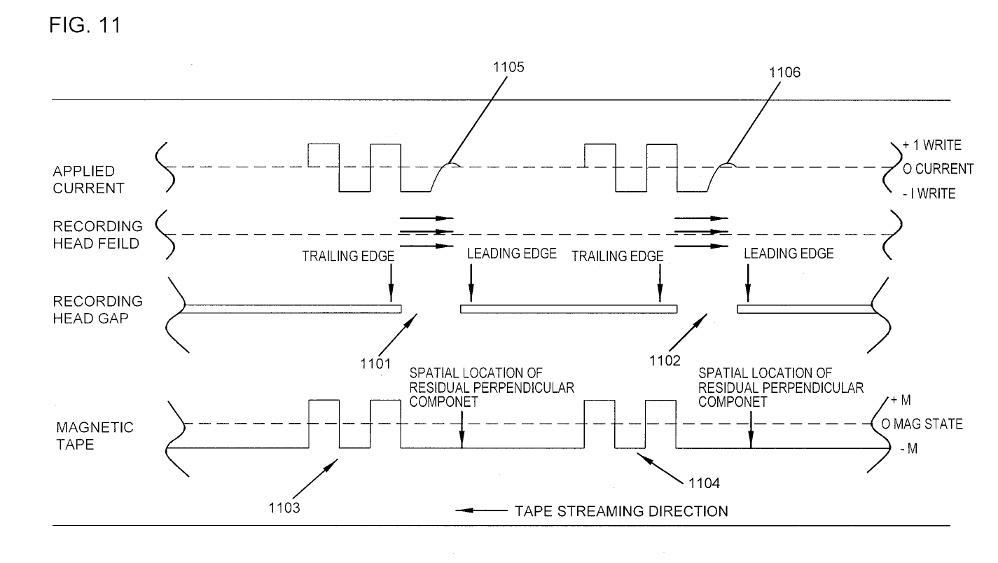

The magnetic read head, used to sense the transitions on tape, may detect components of both the horizontal and perpendicular magnetization states of the media. This may lead to an undesirable residual signal detected by the servo system. This residual magnetization, and the detection profile of the read signal, may be positively affected by the choice of the turn-off electrical current profile used to energize the recording head gap. In addition, the spatial and/or temporal location of the residual signal may be chosen in such a way as to allow the servo system signal electronics and analysis to manage any detected residual signal. FIG. 11 is a schematic representation of bi-polar, trailing edge recording of two recording gaps 1101, 1102 and the resulting bit transitions 1103, 1104 on magnetic media. Here, the last pulse of applied current to the write head 1105. 1106 is shown to have a controlled decay rather than a hard abrupt shut off.

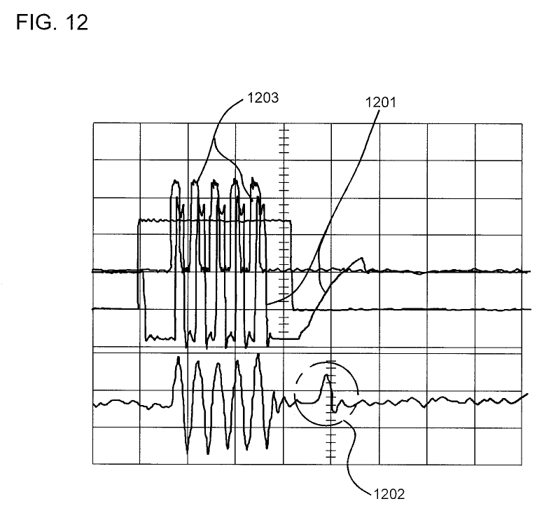

FIG. 12 illustrates the write currents for uni-polar and bi-polar servo writing and the read-back wave form resulting from bi-polar servo writing on tape media which supports a perpendicular component. This media has been Pre-DC Erased. In this embodiment, the bi-polar write current was shut off in a controlled manner. The bi-polar write current is depicted as a dark trace 1201 in this illustrative example while the uni-polar write current is depicted as a light trace 1203. The position and profile of the residual signal 1202 has been modified. Particularly, in one embodiment, by controlling the time, rate or drive-current profile at which the first or last transitions are written, the position of the residual magnetization and signal can be affected and/or controlled. This may be highly advantageous when designing a servo system for advanced tape media. Controlling the residual artifact profile shape and/or the position of an artifact, enables management of the detection of any residual signal by the data storage system. A detected artifact can be affected, such that the servo read channel electronics, software or system can ignore or otherwise handle any undesirable signal from a residual artifact.

Utilizing bi-polar writing and trailing edge recording solves the technical problem of reducing the TBS format magnetic bit length for future generations of TBS recording technology. This technique allows the individual magnetic bit length to be arbitrarily varied to the specification of the servo formatting scheme. Magnetic transitions on tape can be written that are significantly longer, or shorter, than the physical gap width of the magnetic recording head.

Any suitable magnetic recording head having any suitable magnetic recording gaps or gap patterns associated therewith may be used in accordance with the various embodiments of bi-polar and trailing edge, timing-based recording described herein. For example, various embodiments of magnetic recording heads having magnetic recording gaps or gap patterns, and/or methods of making the same, are disclosed in detail in U.S. Pat. No. 6,269,533, titled “Method of Making a Patterned Magnetic Recording Head,” U.S. Pat. No. 7,386,934, titled “Double Layer Patterning and Technique for Milling Patterns for a Servo Recording Head,” U.S. Pat. No. 7,196,870, titled “Patterned Magnetic Recording Head with Termination Pattern Having a Curved Portion,” U.S. Pat. No. 6,496,328, titled “Low Inductance, Ferrite Sub-gap Substrate Structure for Surface Film Magnetic Recording Heads,” U.S. Pat. No. 6,989,960, titled “Wear Pads for Timing-based Surface Film Servo Heads,” U.S. Pat. No. 7,450,341, titled “Integrated Thin Film Subgap Subpole Structure for Arbitrary Gap Pattern Magnetic Recording Heads and Method of Making the Same,” U.S. Pat. No. 7,283,317, titled “Apparatuses and Methods for Pre-Erasing During Manufacture of Magnetic Tape,” U.S. Pat. No. 7,511,907, titled “Stepped Time Based Servo Pattern and Head,” U.S. Pat. No. 7,301,716, titled “Stepped Time Based Servo Pattern and Head,” U.S. Pat. No. 6,947,247, titled “Large Angle Azimuth Recording and Head Configurations,” U.S. Pat. No. 7,106,544, titled “Servo Systems, Servo Heads, Servo Patterns for Data Storage Especially for Reading, Writing, and Recording in Magnetic Recording Tape,” U.S. application No. 11/017,529, titled “Timing-based Servo Verify Head and Method Thereof,” filed Dec. 20, 2004, U.S. application No. 11/061,253, titled “Magnetic Recording Head Having Secondary Sub-gaps,” filed Feb. 18, 2005, U.S. application No. 12/414,604, titled “Thin Film Planar Arbitrary Gap Pattern Magnetic Head,” filed Mar. 30, 2009, and PCT Appl. No. PCT/US09/31798, titled “Recording Heads with Embedded Tape Guides and Magnetic Media Made by Such Recording Heads,” filed on Jan. 23, 2009, each of which is hereby incorporated by reference in its entirety herein.

Although the present invention has been described with reference to preferred embodiments, persons skilled in the art will recognize that changes may be made in form and detail without departing from the spirit and scope of the invention.

We claim:

1. Magnetic media having a timing-based pattern written using a bi-polar energized recording head.

2. The magnetic media of claim 1, wherein the media has been DC erased.

3. The magnetic media of claim 2, wherein the head is energized in such a way that the resulting timing-based pattern is directionally symmetric with respect to the tape streaming direction of the magnetic media.

4. The magnetic media of claim 2, wherein the head is energized in such a way that the resulting timing-based pattern has a controlled bit length for at least one of the first and last magnetic transition of a sequence.

5. The magnetic media of claim 1, wherein the media has been AC erased.

6. The magnetic media of claim 1, wherein the head has a plurality of independent channels.

7. The magnetic media of claim 1, wherein each channel is magnetically energized individually.

8. The magnetic media of claim 1, wherein the head is a surface thin film recording head.

9. The magnetic media of claim 1, wherein the bi-polar energized state of the head is controlled to vary the bit length and bit sequence within the timing-based pattern.

10. The magnetic media of claim 1, wherein the bi-polar energized state of the head is controlled to encode data within the timing-based pattern.

11. The magnetic media of claim 1, wherein the pattern contains both uni-polar and bi-polar transitions.

12. A timing-based pattern written on a magnetic media using a bi-polar energized recording head.

13. The timing-based pattern of claim 12, wherein the timing-based pattern is written utilizing trailing edge recording.

14. A timing-based pattern written on a magnetic media utilizing trailing edge recording.

15. A method for formatting a magnetic media comprising writing a timing-based pattern on the magnetic media using a bi-polar energized recording head.

16. The method of claim 15, wherein the timing-based pattern is written utilizing trailing edge recording.

17. The method of claim 15, further comprising DC erasing the magnetic media.

18. The method of claim 17, wherein the head is energized in such a way that the resulting timing-based pattern is directionally symmetric with respect to the tape streaming direction of the magnetic media.

19. The method of claim 17, wherein the head is energized in such a way that the resulting timing-based pattern has a controlled bit length for at least one of the first and last magnetic transition of a sequence.

20. The method of claim 15, further comprising AC erasing the magnetic media.

21. The method of claim 15, wherein the head has a plurality of independent channels.

22. The method of claim 15, wherein each channel is magnetically energized individually.

23. The method of claim 15, wherein the head is a surface thin film recording head.

24. The method of claim 15, further comprising controlling the bi-polar energized state of the head to vary the bit length and bit sequence within the timing-based pattern.

25. The method of claim 15, further comprising controlling the bi-polar energized state of the head to encode data within the timing-based pattern.

26. The method of claim 15, comprising writing both uni-polar and bi-polar transitions to the magnetic media.

27. The method of claim 15, wherein the servo write head drive-current profile is controlled to affect the form or placement of the first or last pulse of a magnetic formatting sequence.

28. The method of claim 15, wherein the servo write head drive-current profile is controlled to affect the form or placement of a residual signal or artifact.

29. The method of claim 28, wherein the shape or placement of the artifact is chosen to enable management of the signal by the read detection channel or data storage system.
